(19) United States
(12) Patent Application Publication
(10) Pub. No.: US 2024/0291044 A1
(43) Pub. Date: Aug. 29, 2024

(54) Battery Packaging Device

(71) Applicant: Justin Morgan, Lexington, KY (US)

(72) Inventor: Justin Morgan, Lexington, KY (US)

(21) Appl. No.: 18/489,334

(22) Filed: Oct. 18, 2023

Related U.S. Application Data
(60) Provisional application No. 63/447,667, filed on Feb. 23, 2023.

(51) Int. Cl. H01M 10/0587; H01M 10/04

(52) U.S. Cl. CPC H01M 10/0587; H01M 10/0404; H01M 10/0459

(57) ABSTRACT

A battery packaging device is provided. The device allows a user to casily package batteries for recycling by individually rolling, crimping, and cutting a plurality of batteries in plastic tape for transport. To do so, the device has a plurality of rollers, a cutting blade, a cutter, and a crimping bar. Further, the base allows a plurality of tape-enclosed battery rolls to be cut and crimped simultaneously.

### CROSS-REFERENCE TO RELATED APPLICATION

The present application claims priority to, and the benefit of, U.S. Provisional Application No. 63/447,677, which was filed on Feb. 23, 2023, and is incorporated herein by reference in its entirety.

### FIELD OF THE INVENTION

The present invention relates generally to the field of packaging devices. More specifically, the present invention relates to a battery backpacking device that allows a plurality of batteries to be individually wrapped and packaged simultaneously. Accordingly, the present disclosure makes specific reference thereto. Nonetheless, it is to be appreciated that aspects of the present invention are also equally applicable to other like applications, devices, and methods of manufacture.

### BACKGROUND

In the rapidly expanding world of technology and energy storage, the market for lithium battery products continues to grow at an unprecedented rate. As demand increases, so does the pressing need for robust and efficient battery recycling services. Consumers and industries alike are recognizing the environmental importance and potential economic advantages of recycling said batteries. However, a significant challenge emerges when considering the logistics behind this endeavor. Currently, the process of packaging individual batteries and preparing them for transit to recycling facilities is not just tedious and time-consuming, but it also poses potential risks. The volatile nature of lithium batteries demands meticulous handling, and any oversight can lead to dire consequences, both environmentally and in terms of safety. As the industry grapples with this challenge, it underscores the imperative for innovative solutions that can streamline this process and ensure that it's undertaken with the utmost precision and care.

Therefore, there exists a long-felt need in the art for a device for packaging batteries. More specifically, there exists a long-felt need in the art for a battery packing device that allows a plurality of batteries to be packaged for recycling. In addition, there exists a long-felt need in the art for a battery packing device that allows a plurality of batteries to be packaged for recycling in an efficient and simultaneous manner.

The subject matter disclosed and claimed herein, in one embodiment thereof, comprises a battery packaging device. The device allows a user to easily package batteries for recycling. More specifically, the device can be used to individually roll, crimp, and cut a plurality of batteries in plastic tape for transport. To do so, the device has a plurality of rollers, a cutting blade, a cutter, and a crimping bar. Further, the base allows a plurality of tape-enclosed battery rolls to be cut and crimped simultaneously.

In this manner, the battery packaging device of the present invention accomplishes all the forgoing objectives and provides a device for packaging batteries. More specifically, the device allows a plurality of batteries to be packaged for recycling. In addition, the device allows a plurality of batteries to be packaged for recycling in an efficient and simultaneous manner.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a battery packaging device. The device allows a user to easily package batteries for recycling. More specifically, the device can be used to easily roll, crimp, and cut a plurality of batteries in plastic tape for transport.

The device is comprised of at least one tape roll. The roll is stored around at least one first roller and can then be pulled off the roll and fed over top of at least one secondary roller. From the secondary roller, the tape travels through/underneath at least one spring bar and against the bottom of at least one third roller.

The spring bar allows the third roller to move towards at least one fourth roller and at least one fifth roller. At least one battery can be positioned between the rollers such that the rollers allow the battery to spin as tape is applied around the battery by turning at least one handle of the third roller to spin the third roller to feed tape around the battery. After the tape has been successfully spun around the battery to encase the battery, the tape can be cut via at least one cutter.

After the battery has been encased in the tape and the tape has been cut from the roll, the battery can be slid from the rollers to the base of the device, and more specifically within at least one channel of the base. The channel ensures that multiple batteries enclosed in tape rolls are positioned within the base in an organized row pattern. Next, at least one crimping bar can be pressed downward between each battery in the tape roll to crimp the tape between batteries at each end of the tape roll surrounding each battery. Next, at least one cutting blade can be pressed downward through at least one opening in the crimping bar to cut each battery from one another in the tape roll after each battery has been crimped and separated by the crimping bar.

As a result, the device can be used to easily roll at least one battery into a continuous tape roll. Then, the tape roll can be positioned within at least one channel of the base wherein each end of the tape roll can be crimped via at least one crimping bar and severed via at least one cutting blade such that the battery is individually packaged and sealed by the tape.

The present invention is also comprised of a method of using the device. First, a device is provided comprised of at least one roller, at least one cutter, at least one base with at least one channel, at least one cutting blade, and at least one crimping. Then, at least one roll of tape can be placed around the first roller, wherein the tape from the roll can be fed around a second roller and a third roller. Next, at least one battery can be placed on the fourth roller and fifth roller. Then, at least one spring bar (and attached roller) can be pressed downwards toward the fourth roller and fifth roller while at least one handle of the roller is turned to spin the tape around the battery resting atop the rollers. After the tape is spun completely around the battery, the tape can be cut from the roll using at least one cutter. Next, the tape-enclosed battery can be moved into at least one channel of the base, wherein both ends of the tape around the battery can be crimped by at least one crimping bar and cut by at least one cutting blade (which is pressed downward through an opening of the crimping bar).

The present invention is also comprised of a second method of using the device. First, a device is provided comprised of at least one roller, at least one cutter, at least one base with at least one channel, at least one cutting blade, and at least one crimping bar. Then, a roll of tape can be placed around the first roller, and tape from the roll can be fed around a second roller and a third roller. Next, at least one battery can be placed on the fourth roller and fifth roller. Then, at least one spring bar (and attached roller) can be pressed downwards toward the fourth roller and fifth roller while at least one handle of the roller is turned to spin the tape around the battery resting atop the rollers. After the tape is spun completely around the battery, the tape can be cut from the roll using at least one cutter. This process can then be repeated with multiple batteries, which may be in the same roll or separate rolls of tape, wherein each battery is spaced uniformly (using at least one spacing line) from one another in each tape roll. Next, the tape-enclosed battery rolls can be moved into a plurality of channels of the base such the batteries in each tape roll are aligned horizontally. Then, both ends of the tape around each battery can be simultaneously crimped by at least one crimping bar and cut by at least one cutting blade (which is pressed downward through an opening of the crimping bar). This can be achieved by the uniform spacing between each battery within each tape roll.

Accordingly, the battery packaging device of the present invention is particularly advantageous as it provides a device for packaging batteries. More specifically, the device allows a plurality of batteries to be packaged for recycling. In addition, the device allows a plurality of batteries to be packaged for recycling in an efficient and simultaneous manner. In this manner, the battery packaging device overcomes the limitations of existing methods and devices used to package batteries for recycling known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a battery packaging device of the present invention in accordance with the disclosed architecture;

FIG. 2 illustrates a side view of one potential embodiment of a battery packaging device of the present invention in accordance with the disclosed architecture;

FIG. 3 illustrates an enhanced perspective view of a cutter and third roller of one potential embodiment of a battery packaging device of the present invention in accordance with the disclosed architecture;

FIG. 4 illustrates a perspective view of one potential embodiment of a battery packaging device of the present invention in accordance with the disclosed architecture

FIG. 5 illustrates a perspective view of a tape-encased battery made by one potential embodiment of a battery packaging device of the present invention in accordance with the disclosed architecture

FIG. 6 illustrates a flowchart of a method of using one potential embodiment of a battery packaging device of the present invention in accordance with the disclosed architecture; and

FIG. 7 illustrates a flowchart of a method of using one potential embodiment of a battery packaging device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for packaging batteries. More specifically, there exists a long-felt need in the art for a battery packing device that allows a plurality of batteries to be packaged for recycling. In addition, there exists a long-felt need in the art for a battery packing device that allows a plurality of batteries to be packaged for recycling in an efficient and simultaneous manner.

The present invention, in one exemplary embodiment, is comprised of a battery packaging device. The device allows a user to easily package batteries for recycling. More specifically, the device can be used to easily roll, crimp, and cut a plurality of batteries in plastic tape for transport.

The device is comprised of at least one tape roll stored around at least one first roller. The tape roll can then be pulled off the roll and fed over top of at least one secondary roller. From the secondary roller, the tape travels through/underneath at least one spring bar and against the bottom of at least one third roller.

The spring bar allows the third roller to move towards at least one fourth roller and at least one fifth roller. At least one battery can be positioned between the rollers. The rollers allow the battery to spin as tape is applied around the battery by turning at least one handle of the third roller to spin the third roller to feed tape around the battery. After the tape has been successfully spun around the battery to encase the battery, the tape can be cut via at least one cutter.

After the battery has been encased in the tape and the tape has been cut from the roll, the battery can be slid from the rollers to the base of the device, and more specifically within at least one channel of the base. The channel ensures multiple batteries enclosed in tape rolls are positioned within the base in an organized row pattern. Next, at least one crimping bar can be pressed downward between each battery in the tape roll to crimp the tape between batteries at each end of the tape roll surrounding each battery. Next, at least one cutting blade can be pressed downward through at least one opening in the crimping bar to cut each battery from one another in the tape roll after each battery has been crimped and separated by the crimping bar.

As a result, the device can be used to easily roll at least one battery into a continuous tape roll. Then, the tape roll can be positioned within at least one channel of the base wherein each end of the tape roll can be crimped via at least one crimping bar and severed via at least one cutting blade such that the battery is individually packaged and sealed by the tape.

The present invention is also comprised of a method of using the device. First, a device is provided comprised of at least one roller, at least one cutter, at least one base with at least one channel, at least one cutting blade, and at least one crimping. Then, at least one roll of tape can be placed around the first roller, wherein the tape from the roll can be fed around a second roller and a third roller. Next, at least one battery can be placed on the fourth roller and fifth roller. Then, at least one spring bar (and attached roller) can be pressed downwards toward the fourth roller and fifth roller while at least one handle of the roller is turned to spin the tape around the battery resting atop the rollers. After the tape is spun completely around the battery, the tape can be cut from the roll using at least one cutter. Next, the tape-enclosed battery can be moved into at least one channel of the base, wherein both ends of the tape around the battery can be crimped by at least one crimping bar and cut by at least one cutting blade (which is pressed downward through an opening of the crimping bar).

The present invention is also comprised of a second method of using the device. First, a device is provided comprised of at least one roller, at least one cutter, at least one base with at least one channel, at least one cutting blade, and at least one crimping bar. Then, a roll of tape can be placed around the first roller, and tape from the roll can be fed around a second roller and a third roller. Next, at least one battery can be placed on the fourth roller and fifth roller. Then, at least one spring bar (and attached roller) can be pressed downwards toward the fourth roller and fifth roller while at least one handle of the roller is turned to spin the tape around the battery resting atop the rollers. After the tape is spun completely around the battery, the tape can be cut from the roll using at least one cutter. This process can then be repeated with multiple batteries, which may be in the same roll or separate rolls of tape, wherein each battery is spaced uniformly (using at least one spacing line) from one another in each tape roll. Next, the tape-enclosed battery rolls can be moved into a plurality of channels of the base such the batteries in each tape roll are aligned horizontally. Then, both ends of the tape around each battery can be simultaneously crimped by at least one crimping bar and cut by at least one cutting blade (which is pressed downward through an opening of the crimping bar). This can be achieved by the uniform spacing between each battery within each tape roll.

Accordingly, the battery packaging device of the present invention is particularly advantageous as it provides a device for packaging batteries. More specifically, the device allows a plurality of batteries to be packaged for recycling. In addition, the device allows a plurality of batteries to be packaged for recycling in an efficient and simultaneous manner. In this manner, the battery packaging device overcomes the limitations of existing methods and devices used to package batteries for recycling known in the art.

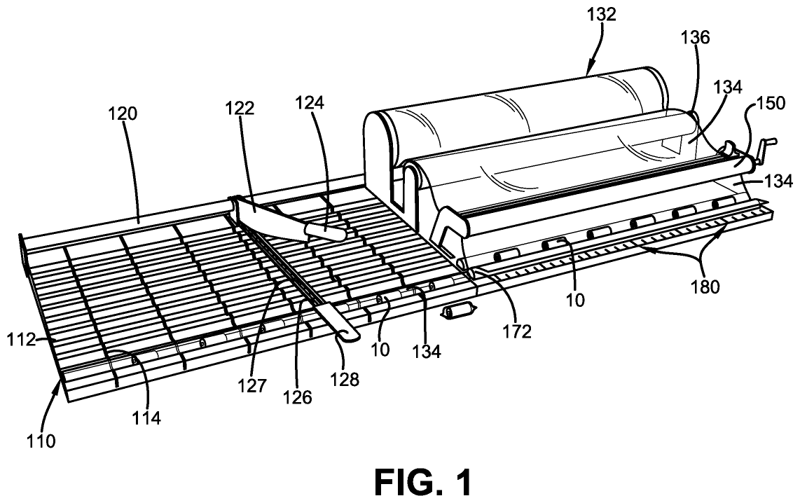

Referring initially to the drawings, FIG. 1 illustrates a perspective view of one potential embodiment of a battery packaging device 100 of the present invention in accordance with the disclosed architecture. The device 100 allows a user to easily package batteries 10 for recycling. More specifically, the device 100 can be used to easily roll, crimp, and cut a plurality of batteries in plastic tape for transport.

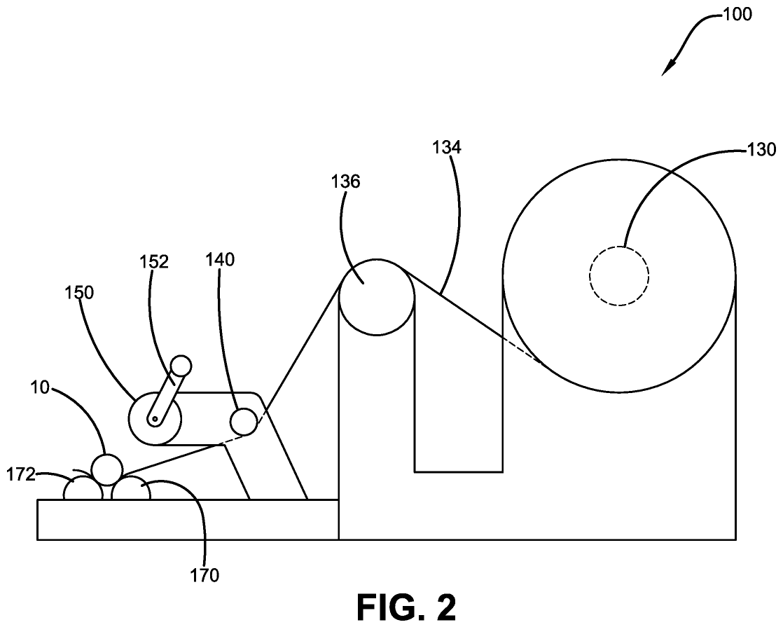

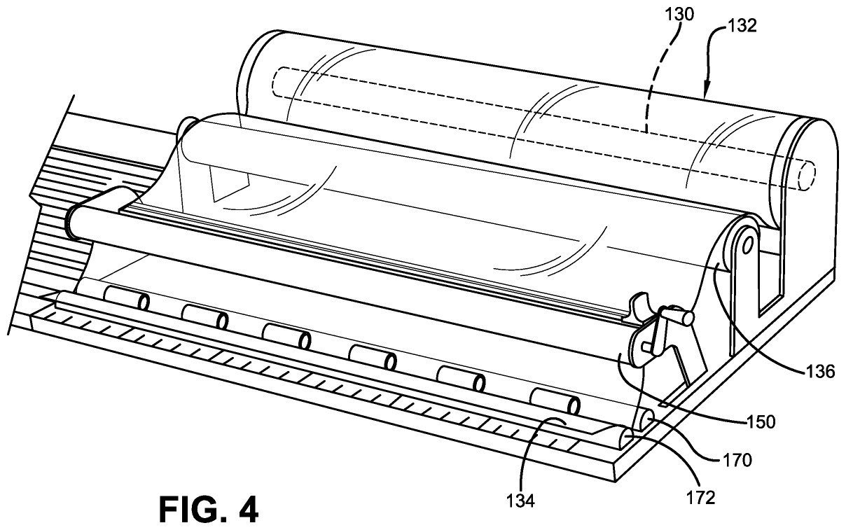

The device 100 is comprised of at least one tape roll 132. Roll 132 is comprised of a tape 134 that is preferably transparent (to allow batteries 10 wrapped in the tape 134 to be easily viewed) and nonconductive. The roll 132 is stored around at least one first roller 130. The tape roll 132 can rotate 360 degrees around the roller 130. Tape 134 can then be pulled off the roll 132 and fed over top of at least one secondary roller 136. From the secondary roller, the tape 134 travels through/underneath at least one spring bar 140 and against the bottom of at least one third roller 150, as seen in FIG. 2. And FIG. 4

The spring bar 140 allows the third roller 150 to move towards at least one fourth roller 170 and at least one fifth roller 172. At least one battery 110 can be positioned between the rollers 170,172 such that the rollers 170,172 allow the battery 10 to spin as tape 134 is applied around the battery 10 by turning at least one handle 152 of the third roller 150 to spin the third roller 150 to feed tape 134 around the battery 10. A user can place at least one, but preferably a plurality of batteries 10 on the rollers 170,172 at once to allow multiple batteries to be secured within one tape 134 roll. To ensure for uniform spacing between each battery 10 (to which the importance will be explained more fully below), at least one measurement/spacing line 180 is printed on the device 100 near the rollers 170,172 to ensure batteries 10 are evenly spaced before being wrapped in tape 134.

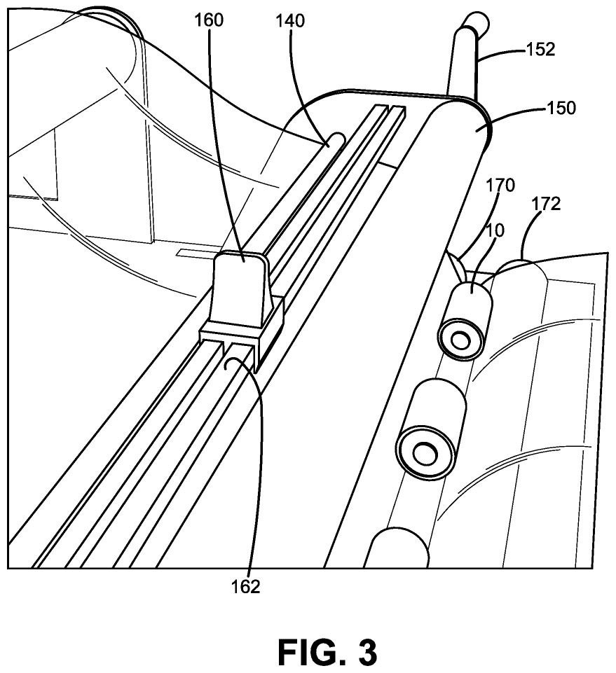

After tape 134 has been successfully spun around the battery 10 to encase the battery 10, the tape 134 can be cut via at least one cutter 160, as seen in FIG. 3. The cutter 160 is a bladed cutter that can move along at least one track 162 positioned in front of or behind the third roller 150 in order to sever a portion of the tape 134 from the tape roll 132.

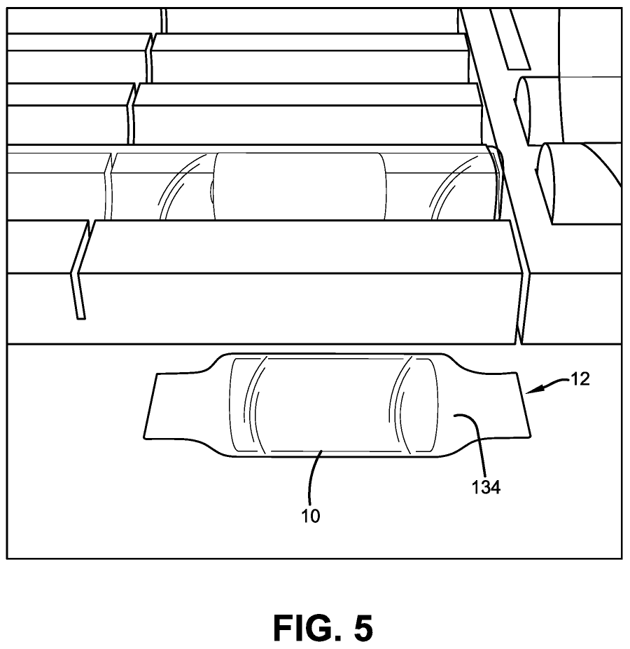

After the battery 10 has been encased in the tape 134 and the tape 134 has been cut from the roll 132, the battery 10 can be slid from the rollers 170,172 to the base 110 of the device 100, and more specifically within at least one channel 112 of the base 110. The channel 112 ensures that multiple batteries 10 enclosed in tape 134 rolls are positioned within the base 110 in an organized row pattern. In the preferred embodiment, a plurality of batteries 10 are placed on the rollers 170,172 such that the batteries 10 are encased in one continuous tape 134 roll. Then, the entire roll 134 can be slid into the channel 112. Next, at least one crimping bar 126 can be pressed downward between each battery 10 in the tape roll to crimp the tape 134 between batteries 10 at each end 12 of the tape roll surrounding each battery 10. Next, at least one cutting blade 122 can be pressed downward through at least one opening 127 in the crimping bar 126. The blade 122 then cuts each battery 10 from one another in the tape 134 roll after each battery 10 has been crimped and separated by the crimping bar 126, as seen in FIG. 5. The blade 122 is received by at least one opening 114 in the base 110.

The cutting blade 122 and crimping bar 126 articulate at least 90 degrees around at least one pivot point 120 such as but not limited to a hinge or a rotating bar. The blade 122 and crimping bar 126 may be repositionable along the pivot point 120 to allow for the roll of batteries 10 enclosed in tape 134 to be crimped and cut at various portions along the roll. The cutting blade 122 and bar 126 may each be comprised of at least one handle 124,128 that allows each component 122,126 to be easily grasped by a user.

As a result, the device 100 can be used to easily roll at least one battery 10 into a continuous tape 134 roll. Then, the tape 134 roll can be positioned within at least one channel 112 of the base 110 wherein each end of the tape 134 roll can be crimped via at least one crimping bar 126 and severed via at least one cutting blade 122 such that the battery 10 is individually packaged and scaled by the tape 134. Further, multiple channels 112 of the base 110 allows a user to simultaneously wrap and separate a plurality of batteries 10 (encased in a plurality of tape 134 rolls) in an efficient manner. In one embodiment, the base 110 has a plurality of channels 112 to allow multiple rows of tape 134 wrapped batteries 10 to be aligned and cut/crimped simultaneously by the blade 122 and crimping bar 126. The size of any component of the device 100 may be adapted for use with any shape, style, and configuration of battery.

Each roller 130,136,150,170,172 of the device 100 is preferably comprised of a non-stick material such as but not limited to PVC. This prevents tape 134 from sticking to the rollers 130,136,150,170,172 during use. Each roller 130,136,150,170,172 can also rotate 360 degrees.

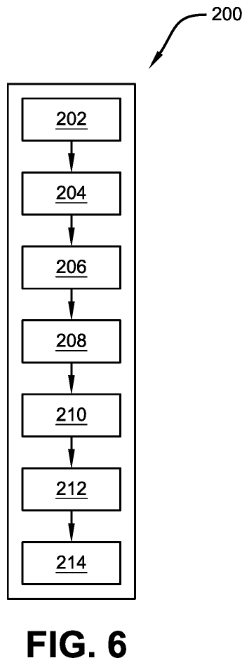

The present invention is also comprised of a method of using 200 the device 100, as seen in FIG. 6. First, a device 100 is provided comprised of at least one roller 130,136,150,170,172, at least one cutter 160, at least one base 110 with at least one channel 112, at least one cutting blade 122, and at least one crimping bar 126 [Step 202]. Then, at least one roll 132 of tape 134 can be placed around the first roller 130, wherein the tape 134 from the roll 132 can be fed around a second roller 136 and a third roller 150 [Step 204]. Next, at least one battery 10 can be placed on the fourth roller 170 and fifth roller 172 [Step 206]. Then, at least one spring bar 140 (and attached roller 150) can be pressed downwards toward the fourth roller 170 and fifth roller 172 while at least one handle 152 of the roller 150 is turned to spin the tape 134 around the battery 10 resting atop the rollers 170,172 [Step 208]. After the tape 134 is spun completely around the battery 10, the tape 134 can be cut from the roll 132 using at least one cutter 160 [Step 210]. Next, the tape 134 enclosed battery 10 can be moved into at least one channel 112 of the base 110, wherein both ends 12 of the tape 134 around the battery 10 can be crimped by at least one crimping bar 126 and cut by at least one cutting blade 122 (which is pressed downward through an opening 127 of the crimping bar 126) [Step 212].

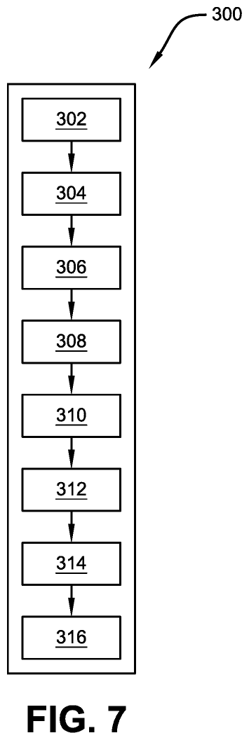

The present invention is also comprised of a second method of using 300 the device 100, as seen in FIG. 7. First, a device 100 is provided comprised of at least one roller 130,136,150,170,172, at least one cutter 160, at least one base 110 with at least one channel 112, at least one cutting blade 122, and at least one crimping bar 126 [Step 302]. Then, a roll 132 of tape 134 can be placed around the first roller 130 and tape 134 from the roll 132 can be fed around a second roller 136 and a third roller 150 [Step 304]. Next, at least one battery 10 can be placed on the fourth roller 170 and fifth roller 172 [Step 306]. Then, at least one spring bar 140 (and attached roller 150) can be pressed downwards toward the fourth roller 170 and fifth roller 172 while at least one handle 152 of the roller 150 is turned to spin the tape 134 around the battery 10 resting atop the rollers 170,172 [Step 308]. After the tape 134 is spun completely around the battery 10, the tape 134 can be cut from the roll 132 using at least one cutter 160 [Step 310]. This process can then be repeated with multiple batteries 10, which may be in the same roll or separate rolls of tape 134, wherein each battery 10 is spaced uniformly (using at least one spacing line 180) from one another in each tape 134 roll [Step 312]. Next, the tape 134 enclosed battery 10 rolls can be moved into a plurality of channel 112 of the base 110 such the batteries 10 in each tape 134 roll are aligned in a horizontal manner [Step 314]. Then, both ends 12 of the tape 134 around each battery 10 can be simultaneously crimped by at least one crimping bar 126 and cut by at least one cutting blade 122 (which is pressed downward through an opening 127 of the crimping bar 126) [Step 316]. This can be achieved by the uniform spacing between each battery 10 within each tape 134 roll.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “battery packaging device” and “device” are interchangeable and refer to the battery packaging device 100 of the present invention.

Notwithstanding the forgoing, the battery packaging device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the battery packaging device 100 as shown in the FIGS. are for illustrative purposes only, and that many other sizes and shapes of the battery packaging device 100 are well within the scope of the present disclosure. Although the dimensions of the battery packaging device 100 are important design parameters for user convenience, the battery packaging device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A battery packaging device comprising:
a first roller;
a second roller;
a tape positioned around a tape roll;
a first cutter;
a pivot point;
a second cutter positioned on the pivot point; and
a crimping bar positioned on the pivot point, the crimping bar comprised of an opening;
a base comprised of a channel.

2. The battery packaging device of claim 1, wherein the first roller is comprised of a non-stick material.

3. The battery packaging device of claim 1, wherein the second roller is comprised of a non-stick material.

4. The battery packaging device of claim 1, wherein the second cutter is comprised of a first handle.

5. The battery packaging device of claim 1, wherein the crimping bar is comprised of a second handle.

6. A battery packaging device comprising:
a first roller;
a tape roll comprised of a tape, the tape roll positioned around the first roller;
a second roller;
a third roller comprised of a spring bar and a handle;
a fourth roller;
a fifth roller;
a first cutter comprised of a track;
a pivot point;
a second cutter positioned on the pivot point; and
a crimping bar positioned on the pivot point, the crimping bar comprised of an opening;
a base comprised of a channel.

7. The battery packaging device of claim 6, wherein the tape is comprised of a transparent tape.

8. The battery packaging device of claim 6, wherein the tape is comprised of a non-conductive tape.

9. The battery packaging device of claim 6 further comprised of a spacing line.

10. The battery packaging device of claim 6, wherein the pivot point is comprised of a hinge.

11. The battery packaging device of claim 6, wherein the pivot point is comprised of a rotating bar.

12. The battery packaging device of claim 6, wherein the handle rotates the third roller.

13. The battery packaging device of claim 6, wherein the base is comprised of an opening.

14. A method of using a battery packaging device, the method comprising the following steps:
providing a battery packaging device comprised of a first roller, a second roller, a third roller, a cutter, a base comprised of a channel, a cutting blade, and a crimping bar;
placing a roll of tape around the first roller and feeding a tape from the roll of tape around the second roller and the third roller;
placing a first battery on a fourth roller and a fifth roller of the first battery packaging device;
dressing a spring bar attached to the third roller downwards toward the fourth roller and the fifth roller while spinning the tape around the first battery;
cutting the tape from the tape roll using the cutter; and
moving the first battery enclosed in the tape into the channel of the base and crimping and cutting a first end and a second end of the tape around the first battery.

15. The method of using a battery packaging device of claim 14 further comprised of a step of placing a second battery on the fourth roller and the fifth roller.

16. The method of using a battery packaging device of claim 14 further comprised of a step of spacing the first battery from the second battery using a spacing line.

17. The method of using a battery packaging device of claim 14, wherein the crimping bar is comprised of an opening.

18. The method of using a battery packaging device of claim 14, wherein the tape is comprised of a transparent tape.

19. The method of using a battery packaging device of claim 14, wherein the tape is comprised of a non-conductive tape.

20. The method of using a battery packaging device of claim 16, wherein the spacing line is positioned on the base.
